(19) United States
(12) Patent Application Publication
(10) Pub. No.: US 2008/0285288 A1
(43) Pub. Date: Nov. 20, 2008

(54) LIGHT-OPTICAL MODULE

(75) Inventors: Andrei A. Kaletin, Ekaterinburg (RU); Olga M. Rosichina, Ekaterinburg (RU); Dmitry V. Tsepelev, Ekaterinburg (RU); Nikolai A. Osipov, Chernogolovka (RU); Nikolai F. Vershinin, Chernogolovka (RU)

Correspondence Address: HOUSTON ELISEEVA, 4 MILITIA DRIVE, SUITE 4, LEXINGTON, MA, 02421, US

(73) Assignee: ZAO ZAVOD EMA, Ekaterinburg (RU)

(21) Appl. No.: 12/175,592

(22) Filed: Jul. 18, 2008

Related U.S. Application Data
(63) Continuation of application No. PCT/RU2006/000020, filed on Jan. 24, 2006.

(51) Int. Cl. F21V 7/00

(52) U.S. Cl. 362/310

(57) ABSTRACT

The aim of the invention is to increase the accuracy of adjustment by simplifying the adjustment of each light-optical module of a lighting device. The aim is attained by means of the inventive light-optical module comprising an annular holder provided with a core which is arranged in the center thereof and connected thereto by three strengthening ribs, a reflector and a light-emitting element embodied in the form of a light-emitting diode. Said light-emitting diode is arranged in a nest embodied in the core on the reflector side. The annular holder is connected to the reflector by means of a threaded joint and the mounting surface thereof arrangeable in the lighting device body is shaped in the form of a cone. The inventive annular holder, the core and the strengthening ribs are made of a heat-conducting material.

### RELATED APPLICATIONS

This application is a Continuation of PCT application serial number PCT/RU2006/000020 filed on Jan. 24, 2006, which is incorporated herein by reference in their entirety.

### FIELD OF THE INVENTION

This invention relates to lighting devices intended for illuminating localized surfaces and may find use for illuminating objects which require high quality of illumination, more particularly in medical lighting devices for illuminating internal cavities during an operation.

### BACKGROUND OF THE INVENTION

With the emergence of light-emitting diodes (LEDs), the latter have found wide use in sources of light thanks to their long service life, compactness, low energy consumption and emission in a narrow spectrum. For manufacturing sources of light, both matrix LED panels and individual LEDs may be used as components.

Known is a lighting device having a body, matrix LEDs or LEDs affixed on a circuit board, and a light-diffusing panel (see patent of the Russian Federation for utility model No. 27852, IPC F27V11/00, F21S4/00 published on Feb. 20, 2003).

The disadvantage of the known device is the complexity of adjustment of the lighting device.

Known is a light-optical module used to illuminate objects, said module comprising a source of light made of LEDs, a reflector, and a collimating lens (see the patent of the Russian Federation No. 2187039, IPC F21L4/00 published on Aug. 10, 2002).

The luminous flux produced by the known source of light features extensive diffusion, making said luminous flux difficult to focus.

Known is a linear LED module comprising a body wherein LEDs are arranged along the optical axis of the module and the central axes of the luminous fluxes coincide with the optical axis of the module (see the patent of the Russian Federation No. 2253887, IPC G02B6/42, F21S13/14 published on Jul. 10, 2003).

The disadvantage of the known device is the complexity of adjustment whereby each LED should be adjusted individually.

Known is a shadowless cold-light device for stereomicroscopes comprising a ring with lighting elements in the form of a plurality of LED modules, and a power source. Each LED module presents one LED of high brightness affixed to a rod mounted in one of the nests of the ring on a spherical joint enabling longitudinal movement therein (see the patent of the Russian Federation No. 2252441, IPC G02B21/06, published on May 20, 2005).

The disadvantage of the known light-optical module consists in large dimensions thereof. Moreover, where a lighting device comprises a plurality of such LED modules each of such modules has to be adjusted individually.

Technically, the most close to the claimed technical solution is a light-optical module comprising an annular member, a reflector, a light-emitting element, and a means for affixing the light-emitting element (see the patent of the Russian Federation No. 2149309, IPC F21V14/02, F21V21/29, F21W131/205 published on May 20, 2000).

The disadvantage of this light-optical module is the need to adjust the position of each of the light-optical modules included in the lighting device.

### SUMMARY OF THE INVENTION

The technical result of this invention is increased accuracy of adjustment owing to simplified adjustment of each of the light-optical modules included in the lighting device.

This technical result is attained owing to the fact that in the light-optical module comprising an annular holder, a reflector, a light-emitting element and a means for affixing the light-emitting element in accordance with the claimed technical solution the center of the annular holder accommodates a core connected by means of strengthening ribs with the annular holder, wherein the core on the side of the reflector has a nest in which the light-emitting element is mounted, the annular holder and the reflector being connected with each other by means of a threaded joint and the light-emitting element presenting a light-emitting diode.

The mounting part of the external surface of the annular holder is shaped like a cone.

Besides, the annular holder with the core and the strengthening ribs is made of heat-conducting material.

Furthermore, the core is connected with said annular holder with the aid of three strengthening ribs.

The construction of the annular holder with strengthening ribs and the core located in the center of the holder and the provision of a nest in the core on the side of the reflector allows the mounting therein of a light-emitting element represented by a light-emitting diode on the optical axis of the light-optical module, which increases the accuracy of adjustment. The threaded joint of the annular holder and the reflector increases the accuracy of positioning the reflector and the LED and simplifies the adjustment of the light-optical module.

The conical shape featured by the mounting part of the external surface of the annular holder which is conjugate with the body of the lighting device having a hole into which the light-optical module is mounted ensures automatic alignment of the light-optical module during mounting thereof in the body, which also increases the accuracy of adjustment.

The construction of the annular holder with the core and the strengthening ribs made of a heat-conducting material ensures the removal of the heat generated during the operation of the light-optical module due to release from the LED.

Moreover, the connection of the core with the annular holder by means of strengthening ribs ensures the required stiffness of the construction. The use of three strengthening ribs for this purpose is optimal. The use of two strengthening ribs does not ensure the required stiffness of the construction, whilst the use of more than three strengthening ribs does not change the stiffness of the construction.

The presence of essential features which are distinct from the prototype makes it possible to regard the claimed technical solution as novel.

No technical solutions have been revealed from the prior knowledge, which would coincide with the distinctive features of the claimed invention, therefore the claimed device meets the criterion of an inventive level.

The possibility of embodying the claimed invention in industry makes it possible to regard it as meeting the criterion of industrial applicability.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a cross-section view of the light-optical module.

FIG. 2 is a top view of the light-optical module without light-emitting diode.

FIG. 3 is an A-A cross sectional view in FIG. 2.

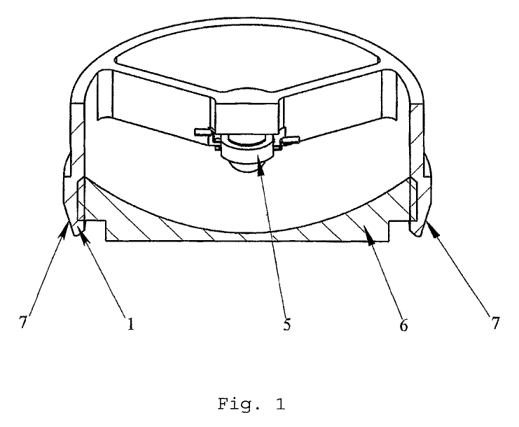

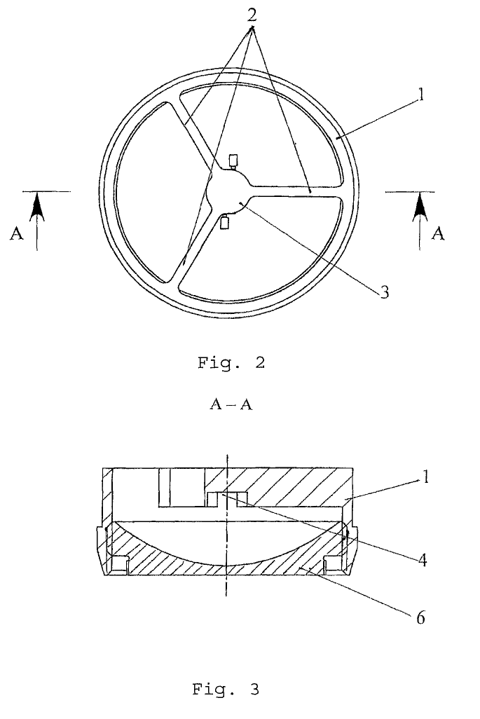

### DETAILED DESCRIPTION OF THE PREFERRED EMBODIMENTS

The light-optical module comprises annular holder 4 having three strengthening ribs 2 and core 3 in which nest 4 is made for mounting light-emitting diode 5 therein, and reflector 6. Annular holder 1 is connected with reflector 6 with the aid of a threaded joint. Light-emitting diode 5 is cemented to the bottom of nest 4. Mounting surface 7 of annular holder 1 is shaped conically for mounting the lighting device in the conical hole in the body (not shown). Annular holder 1 with core 3 and strengthening ribs 2 are made of a heat-conducting material, for example, an aluminum alloy.

The construction of the claimed light-optical module ensures automatic alignment between the axis of the module and the axis of emission, that is between the mechanical axis of the module and the optical axis of the luminous beam thereof.

The embodiment of the mounting part of the annular holder and the nest for mounting thereof in the body of the lighting device in a conical form automatically ensures a given orientation of the mechanical axis of the light-optical module relative to the main axis of the lighting device. Thus, accurate alignment may be ensured between the light beam of the light-optical module and the main axis of the lighting device.

While this invention has been particularly shown and described with references to preferred embodiments thereof, it will be understood by those skilled in the art that various changes in form and details may be made therein without departing from the scope of the invention encompassed by the appended claims.

What is claimed is:

1. A light-optical module comprising:
an annular holder with a core arranged in a center of the annular holder;
a reflector; and
a light-emitting element;
wherein the core is engaged with the annular holder via stiffening ribs;
wherein the core comprises a nest facing the reflector, in which nest the light-emitting element is placed;
wherein the annular holder and the reflector are mutually engaged via a threaded join; and
wherein the light-emitting element is a light-emitting diode.

2. The light-optical module of claim 1, wherein a mounting part of the annular holder has a conical shape.

3. The light-optical module of claim 1 wherein the annular holder, the core and the stiffening ribs are made of a heat-conducting material.

4. The light-optical module of claim 1 wherein the core is engaged with the annular holder with via three stiffening ribs.
